(19) United States
(12) Patent Application Publication
(10) Pub. No.: US 2007/0211984 A1
(43) Pub. Date: Sep. 13, 2007

(54) Optical coupler

(76) Inventors: Anand Gopinath, Wayzata, MN (US); Jaesang Oh, St. Paul, MN (US); Ross T. Schermer, Roseville, MN (US)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/801,709

(22) Filed: May 10, 2007

Related U.S. Application Data
(63) Continuation of application No. 10/850,358, filed on May 20, 2004.
(60) Provisional application No. 60/472,018, filed on May 20, 2003.

(51) Int. Cl. G02F 1/035; G02F 1/01; G02B 6/10; G02B 6/26; G02B 6/42

(52) U.S. Cl. 385/3; 385/1; 385/2; 385/39; 385/40; 385/129; 385/130; 385/132; 385/43

(57) ABSTRACT

A optical coupler is formed on a substrate and includes a first and elongate optical waveguides. Variable coupling is provided between the first and second elongate optical waveguides. In an optical modulator, a plurality of phase shifts are provided along the waveguides to increase linearity of a response of the modulator.

The present application is a Continuation and claims the benefit of U.S. Ser. No. 10/850,358, filed May 20, 2004, which is based on and claims the benefit of U.S. provisional patent application Ser. No. 60/472,018, filed May 20, 2003, the content of which is hereby incorporated by reference in its entirety.

### BACKGROUND OF THE INVENTION

The present invention relates to optical devices. More specifically, the present invention relates to optical couplers.

Optical devices are finding increasingly widespread use in various fields such as communications, data processing, storage, and other technologies. In some cases, optical components are completely supplanting the equivalent electrical components. In other situations, components are manufactured which have both electrical and optical characteristics for use in hybrid technologies.

In many instances, optical components perform functions which are similar to their electrical equivalents. For example, optical couplers are used to allow more than one optical signal to interact with each other or in some way provide an interrelationship between the two signals. One type of optical coupler uses two waveguides which are run parallel to each other. Each waveguide is configured for coupling to separate optical fibers. As optical signals are passed from the optical fibers to the waveguides, the signals propagate along the waveguides. Due to the close proximity and optical characteristics of the waveguides, interaction between the two signals occurs. For example, one signal can be used to modulate an optical signal in the other fiber, one signal can be used to induce an optical signal in another fiber, etc. However, in many instances, optical couplers have undesirable optical characteristics which cannot be easily controlled.

### SUMMARY OF THE INVENTION

An optical coupler includes a substrate which carries a first elongate optical waveguide on the substrate. A second elongate optical waveguide extends adjacent to and generally parallel with the first elongate optical waveguide. A trench extends between the first elongate optical waveguide and the second elongate optical waveguide and is configured to provide variable coupling therebetween. In one aspect, an optical modulator is provided in which a plurality of phase shifts are positioned along a length of first and second waveguides and are configured to provide a linear response in the modulator.

### BRIEF DESCRIPTION OF THE DRAWINGS

FIG. 1 is a schematic diagram of an optical coupler modulator.

FIG. 2 is a perspective view of one example embodiment of an optical coupler of coupler modulator.

FIG. 3 is a graph of normalized intensity response versus normalized bias for an optical coupler calculated using coupled mode theory.

FIG. 4A is a graph of the coupling function versus distance along a coupler obtained using a Fourier transform method.

FIG. 4B is a graph of amplitude response versus normalized bias.

FIG. 5 is a schematic diagram of a variable spacing optical coupler. λ/2 phase shift sections can be placed in the top arm where the spacing increases to achieve substantially zero coupling.

FIG. 6 is a schematic diagram of a parallel guide optical modulator having curved sections to provide phase changes.

FIG. 7 is a cross-sectional view of a optical coupler having a ridge guide configuration and a stepped trench therebetween.

FIG. 8 is a graph showing the response of a stepped etched ridge guide structure in accordance with FIG. 7 versus applied voltage.

FIG. 9A is a graph of the normalized coupling coefficient versus normalized distance for initial coupling function obtained using a Fourier transform method and a final coupling function obtained using an iterative Newton's method.

FIG. 9B is a graph of a real part of a response versus normalized frequency.

FIG. 9C is a graph of the imaginary part of the response versus normalized frequency for a dispersion compensator using the final coupling function.

FIG. 10 is a graph of intensity versus modulator drive voltage for a desired trapezoidal response function which provides a substantially constant modulator response and a steep response at the switching voltage.

FIG. 11 is a schematic diagram of the phase-shifted directional coupler modulator. Two identical optical waveguides placed parallel to each other form a directional coupler of length L=2L_{C}. Four phase shifts are placed as shown, which delay the electric fields in one waveguide with respect to the other by 180°. R and S are the normalized electric fields. Electrodes on each waveguide (not shown) convert a constant optical input, |Rᵢₙ|²=1 to a modulated optical signal, |Sₒᵤₜ|^{2.}

FIG. 12 is a graph of the intensity response of the phase-shifted directional coupler modulator (solid line), linear least squares fit to the region 0.3≦|S|²≦0.6 (dotted line), and intensity response of the conventional directional coupler modulator (dashed line). The value of 2δL/π to switch the modulator was 3.54, as compared to √3=1.73 for the simple directional coupler. The upper axis, V/V_{Switch} corresponds to V_{Switch} for the phase-shifted design.

FIG. 13 is a graph of electrical power in the fundamental signal (●), second harmonics (▴), third harmonics (▾), IMD2 (♦), and IMD3 (▪), for link parameter set A in Table I and bias V_{Bias}/V_{Switch}=0.5583. Plotted versus RF input power. The horizontal line marks the noise level, and the vertical line shows that the SFDR was 84.4 dB in 1 MHz.

FIG. 14 is a graph of electrical power in the fundamental signal (●), second harmonics (▴), third harmonics (▾), IMD2 (♦), and IMD3 (▪), for link parameter set B in Table I and bias V_{Bias}/V_{Switch}=0.545. Plotted versus RF input power. The horizontal line marks the noise level, and the vertical line shows that the SFDR was 125.0 dB in 1 MHz.

### DETAILED DESCRIPTION OF THE PREFERRED EMBODIMENTS

Optical co-directional couplers have been used in a variety of applications, including 2×2 switches, 3 dB splitters, modulators, filters, and also in combination with other devices. In most of these instances, these couplers have had constant coupling. However, in Titanium-Diffused Lithium Niobate Waveguide Devices, in Guided Waveguide Devices second edition, pp. 145-210, 1988), Alferness describes variable coupling which is implemented using weighted coupling filters.

The present invention is related to variable coupling in optical couplers. Coupling engineering concepts and appropriate synthesis techniques may by used to design directional couplers as modulators with specified response functions. For example filters with specific amplitude and phase response, switches with specific switching voltages, dispersion compensators with specified amplitude and phase response, among other applications. In general, the synthesis methods for the variable coupling coupler can lead to complex coupling functions for amplitude and phase, the realization of which proves to be difficult. However, with careful formulation, the synthesis yields coupling functions that have only positive and negative coupling components. This change of sign may be implemented by introducing an extra half-wavelength at the center wavelength on one side of the coupler arms at the appropriate point to obtain the required 180° phase shift, to change the sign of the coupling function. Additionally, the present invention can be used to implement other components such as those listed above.

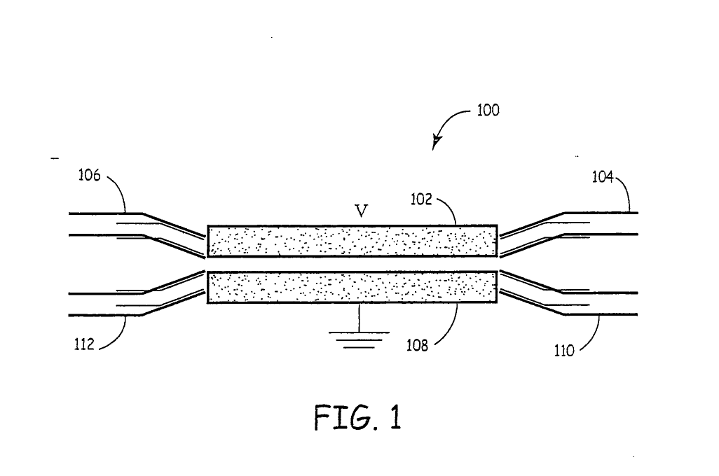

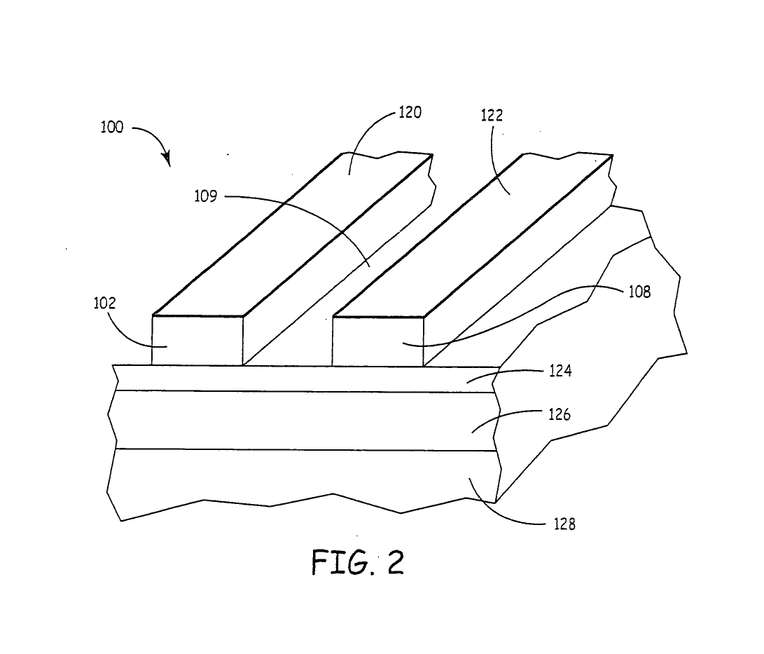

FIG. 1 is a simplified schematic diagram of an optical coupler 100 having a first waveguide 102 coupled to optical fibers 104 and 106 and a second waveguide coupled to optical fibers 110 and 112. Waveguides 102 and 108 are shown as extending in a parallel direction and are aligned in a single plane. FIG. 2 is a perspective view of coupler 100 which shows electrodes 120 and 122 which overly waveguides 102 and 108, respectively. In FIG. 2, waveguides 102 and 108 are illustrated as ridge waveguides. The trench 109 between the waveguides 102 and 108 is shown as having a constant height. Electrodes 120 and 122 are carried on cladding layer 124 which overlies a guide layer 126. The entire structure is supported on a substrate 128. The present invention is related to providing variable coupling between the two waveguides 102 and 108 illustrated in FIG. 1.

Optical modulators are used to modulate optical signals. External optical modulators are typically used in fiber optical systems since direct modulation of lasers leads to spectral broadening. Optical modulators may take different forms. Example couplers include electro-optic modulators which use the linear electro-optic effect or the Pockel's effect and the electro-absorption modulators which may utilize the quantum confined Stark effect or the Franz-Keldysh effect. (See for example, N. Dagli, Wide-bandwidth lasers and modulators for RF photonics, IEEE Transactions on Microwave Theory & Techniques, vol. 47, pp. 1157-1171, 1999 and R. B. Welstand, J. T. Zhu, W. X. Chen, A. R. Clawson, P. K. L. Yu, and S. A. Pappert, “Combined Franz-Keldysh and Quantum-Confined Stark Effect Waveguide Modulator for Analog Signal Transmission,” Journal of Lightwave Technology, Vol. 17, pp. 497-502, 1999.) The most commonly used device is the Mach-Zehnder interferometer using the Pockel's effect in lithium niobate (See for example, N. Dagli, Wide-bandwidth lasers and modulators for RF photonics, IEEE Transactions on Microwave Theory & Techniques, vol. 47, pp. 1157-1171, 1999 and R. Alfterness, Titanium-Diffused Lithium Niobate Waveguide Devices, in Guided Wave Optoelectronics, Editor: T. Tamir, Springer-Verlag, second edition, pp. 145-210, 1988). The Stark effect electro-absorption modulator may be integrated with the laser source with careful epitaxial growth techniques.

The Mach-Zehnder interferometer in lithium niobate is widely used particularly for long haul applications where the chirp performance is very important. The chirp generated in these devices is negligible and may also be deliberately introduced. The optical insertion loss is in the 5 to 7 dB range. These devices, with velocity matched traveling wave electrode structures for frequency response to the 40 Gbps range, have switching voltages of the order of 4 V to 10 V. The intensity response function of the modulated signal with linear voltage drive is of the form [1+cos(πV_{drive}/V_{drive}/V_{π})]². (See for example, R. Alfterness, Titanium-Diffused Lithium Niobate Waveguide Devices, in Guided Wave Optoelectronics, Editor: T. Tamir, Springer-Verlag, second edition, pp. 145-210, 1988). While most of these modulators are based on LiNiBO₃, a body of work also exists on III-V semiconductor based devices. (See for example, R. G. Walker, High speed III-V semiconductor intensity modulators, IEEE J. Quantum. Electronics, vol. 27, pp. 654-667, 1991). The coupler modulator is an alternative electro-optic modulator, both in lithium niobate and semiconductor material. (See for example, J. P. Donnelly, A. Gopinath: A comparison of power requirements of traveling-wave LiBnO3 optical couplers and interferometric modulators, IEEE J. Quantum Electron, Vol. QE-23, pp. 30-41, 1987 and M. Nisa Khan, Wei Yang, Anand Gopinath, Directional coupler electrooptic modulator in Al-GaAS/GaAs with low voltage-length product, Appl. Phy. Lett., Vol 62, pp. 2033-2035, 1993).

The present invention includes a variable coupling co-directional coupler modulator using the linear electro-optical effect, in which the design of the modulator structure is synthesized to obtain a desired response function. The attraction of this device is that in principle any response function, amplitude and phase may be obtained from the synthesized design.

Referring back to FIGS. 1 and 2, a standard coupler modulator such as modulator 100 has two identical optical waveguides 102 and 108 placed in close proximity to each other so that the gap between them is a constant. Gap distances can range from 1 to 30 μm. The coupled waveguides are designed to support only two super modes at the wavelength of operation, one odd and the other even. Analysis of these supermodes indicates that these odd and even modes have different velocities. Excitation of an optical signal on one of the guides is in fact the excitation of the superposition of both these modes, so that they add constructively on the excited guide, and add destructively in the other guide. The modes travel at different velocities as they move down the guides, and the phase relationship changes so that at some distance downstream, the modes interfere constructively in the second guide but add destructively in the excited guide. This distance is defined as the coupling length of the coupler. Placing this device of one coupling length in linear electro-optic effect material allows the index of the individual guides to be altered, to increase and decrease their indices by means of electric fields generated using electrodes 120 and 122. This effectively decreases the coupling length and changes the power transfer, since the guides are no longer identical, so that the light in the excited guide emerges from it at the end of the coupler. FIG. 1 shows a schematic diagram of this device 100 with a constant gap, and hence constant coupling, and FIG. 2 shows a perspective of a ridge waveguide implementation.

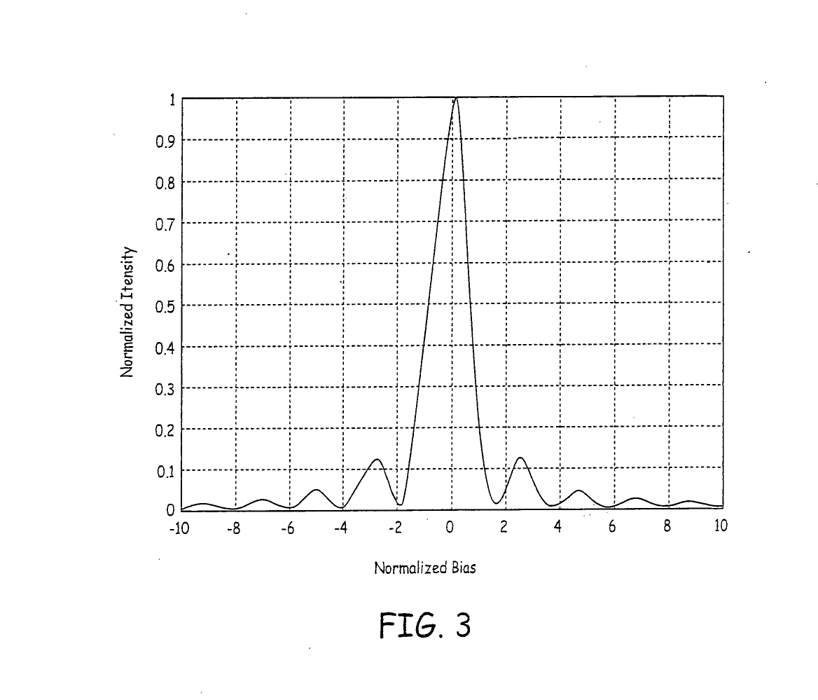

The electro-optic coupler shown in FIGS. 1 and 2 can act as a switch or a modulator when used with an applied bias. It can be shown that a constant gap and the resultant constant coupling results in the sinc response function for the signal against bias, shown in FIG. 3. This sinc² intensity response can be seen as following a sinc² function and is a highly nonlinear response.

Theoretical work has shown that the grating assisted contra-directional coupler filters may be synthesized by two methods, the first, using the inverse scattering technique based on the theory of Gel'fand, Levitan, and Marchenko, i.e., the “GLM” method, (See for example, G.-H. Song, S. Y. Shin, Design of corrugated waveguide filters by the Gel'fand-Levitan-Marchenko inverse scattering method, J. Opt. Soc. Am. A, vol. 2, pp. 1905-1915, 1985), which requires that the response function be expressed as a rational polynomial. This has resulted in modulator designs based on the usual Butterworth and Chebyschev designs, which are both polynomial functions widely used in electrical filter designs. Work by Peral (See for example, Eva Peral, Jose Capmany and Javier Marti “Iterative Solution to the Gel-Fand-Levitan-Marchenko Coupled Equations and Application to Synthesis of Fiber Gratings”, IEEE J. Quantum Electronics, Vol. 32 pp. 2078-2084, 1996) has shown an iterative scheme that may be used with the GLM method to circumvents the need to express the desired response as a rational polynomial. The second synthesis method is the Fourier transform method (See for example, K. Winick, Design of corrugated waveguide filters by Fourier transform techniques, IEEE J. Quantum. Electronics, vol. 26, pp. 1918-1929, 1990), which is discussed by Alferness in Tamir's book (See R. Alfterness, Titanium-Diffused Lithium Niobate Waveguide Devices, in Guided Wave Optoelectronics, Editor: T. Tamir, Springer-Verlag, second edition, pp. 145-210, 1988) which assumes that the coupling is very small, and thus the method is at best approximate. A detailed design with the Fourier method for a grating coupled filter is discussed in K. Winick, Design of corrugated waveguide filters by Fourier transform techniques, IEEE J. Quantum. Electronics, vol. 26, pp. 1918-1929, 1990) for a grating coupled filter. Thus, the methodology used in these designs has been discussed in the open literature since the 1970s.

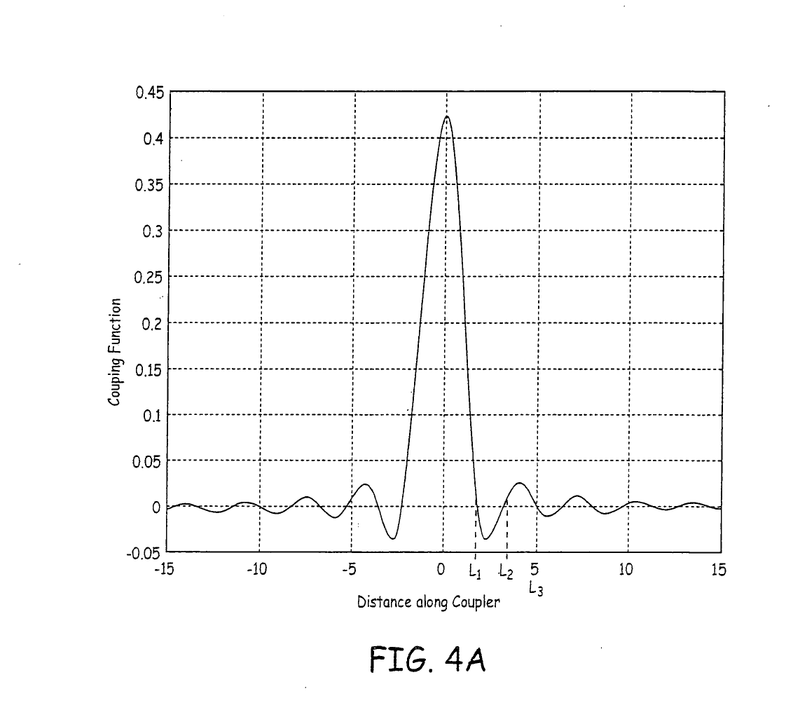

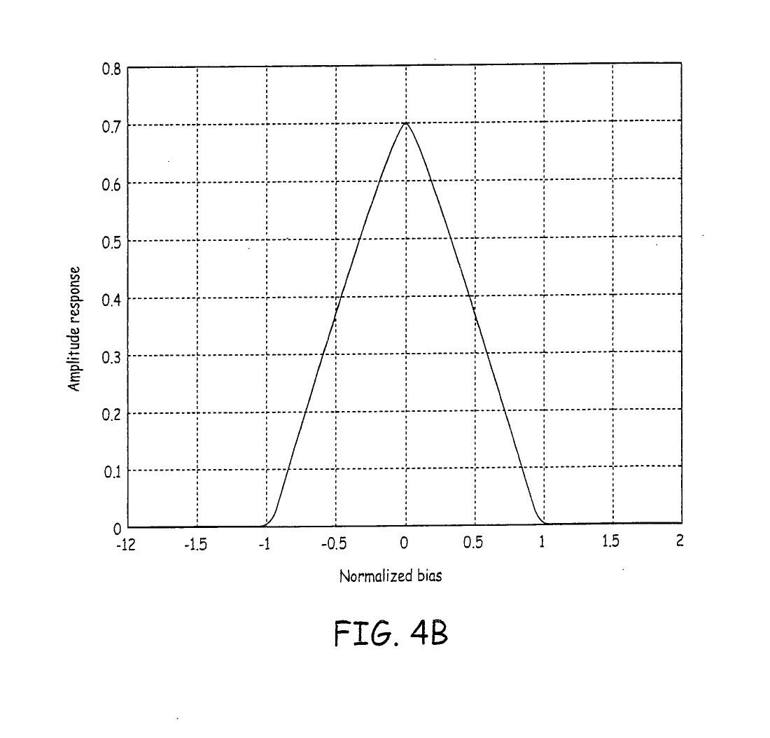

The application of this methodology to suitably modified co-directional coupler modulator, has only recently been performed. (See for example, S. W. Løvseth, Optical directional couplers using the linear electro-optic effect for use as modulators and filters, Dipl. Engineer thesis, Physics Department, Norwegian University of Science and Technology, May 20, 1996; S. W. Løvseth, C. Laliew, A. Gopinath, Amplitude response of optical directional coupler modulator by the Fourier transform technique, Proceedings of the 8^{th} European Conference on Integrated Optics, pp. 230-233, April 1997; S. W. Løvseth, C. Laliew, A. Gopinath, Synthesis of amplitude response of optical directional coupler modulators, 1997 IEEE-MTT-S International Microwave Symposium digest, vol III, pp. 1717-1720, June 1997; Anand Gopinath, Chanin Laliew, Sigurd Løvseth, Synthesis of the of optical modulator re-sponse, IEEE International Topical Meeting on Microwave-Photonics Technical Digest, paper MC-4, pp. 41-43, 12-14 October 1998, Princeton, N.J. (Invited Talk); Chanin Laliew, Xiaobo Zhang, Anand Gopinath, Linearized optical directional modulator, Integrated Photonics Research Meeting, July 1999, Santa Barbara, Calif.; C. Laliew, X. Zhang, A. Gopinath, Linearized optical directional-coupler modulators for analog Rf/Microwave transmission systems, IEEE MTT-S International Microwave Symposium, pp. 1829-1832, Boston, Mass., June 2000; T. Li, C. Laliew, A. Gopinath, An iterative transfer matrix inverse scattering technique for synthesis of co-directional couplers and filters, IEEEJ. Quantum Electronics, vol. 38, pp. 375-379, April 2002. For a specified output response function, usually expressed in terms of output light intensity, the coupling between the guides needs to be determined so that this response is generated. In the above papers (see S. W. Løvseth, C. Laliew, A. Gopinath, Amplitude response of optical directional coupler modulator by the Fourier transform technique, Proceedings of the 8^{th} European Conference on Integrated Optics, pp. 230-233, April 1997; S. W. Løvseth, C. Laliew, A. Gopinath, Synthesis of amplitude response of optical directional coupler modulators, 1997 IEEE-MTT-S International Microwave Symposium digest, vol III, pp. 1717-1720, June 1997) it has been shown that both the GLM method and the Fourier transform technique may be used to obtain the coupling function. Recent experimental work has shown that the Fourier method yields designs when fabricated show response functions close to the specified functions (see for example, T. Li, C. Laliew, A. Gopinath, An iterative transfer matrix inverse scattering technique for synthesis of co-directional couplers and filters, IEEEJ. Quantum Electronics, vol. 38, pp. 375-379, April 2002; C. Laliew, S. Løvseth, X. Zhang, A. Gopinath: Linear optical coupler modulators, J. Light-wave Tech., Vol. 18, pp. 1244-1249, 2000). In these experiments, the coupling function was obtained by performing the Fourier transform of the square root of the intensity response, since the coupling function and the output field response are Fourier transform pairs. The conversion of this coupling function to the actual device design requires additional steps. A typical linear response function triangular shaped results in the coupling function shown in FIG. 4A. FIG. 4B shows the response function which is obtained with this coupling function truncated with three lobes on each side, which is different from the original desired linear response function. Note also that the Fourier transform coupling function does not reach unity on a normalized scale.

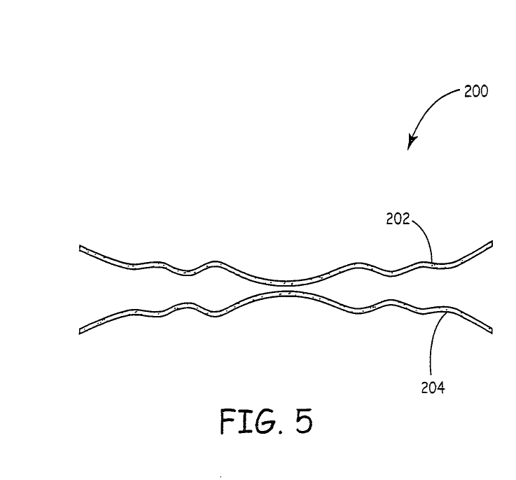

One design of the variable coupling directional coupler modulator was realized in III-V semi-conductor material, GaAs/AlGaAs, designed to operate at 1300 nm wavelength, and designed to have a linear response of the form shown in FIG. 4 (See C. Laliew, S. Løvseth, X. Zhang, A. Gopinath: Linear optical coupler modulators, J. Light-waveTech., Vol. 18, pp. 1244-1249, 2000. The major innovation of this design was the realization of a negative coupling function by providing a phase shift of 180°. The phase shift was achieved using an increased length in one of the arms of the coupler. FIG. 5 is a schematic diagram of the variable spacing modulator, with λ/2 phase shift sections in the top arm when the spacing increases for almost zero coupling. (See for example, C. Laliew, S. Løvseth, X. Zhang, A. Gopinath: Linear optical coupler modulators, J. Light-wave Tech., Vol. 18, pp. 1244-1249, 2000). In coupler 200 shown in FIG. 5, the variation of the coupling function is obtained by varying the spacing between the guides 202 and 204. A problem with this approach is that the switching voltage (or the vπ) becomes large, and therefore the device is useful only when low modulation depths are required. In one experiment the switching voltage was estimated at 48 V, and only the 0 V to 12 V was used to evaluate the linearity, because the material broke down when the voltage increased beyond 17 V.

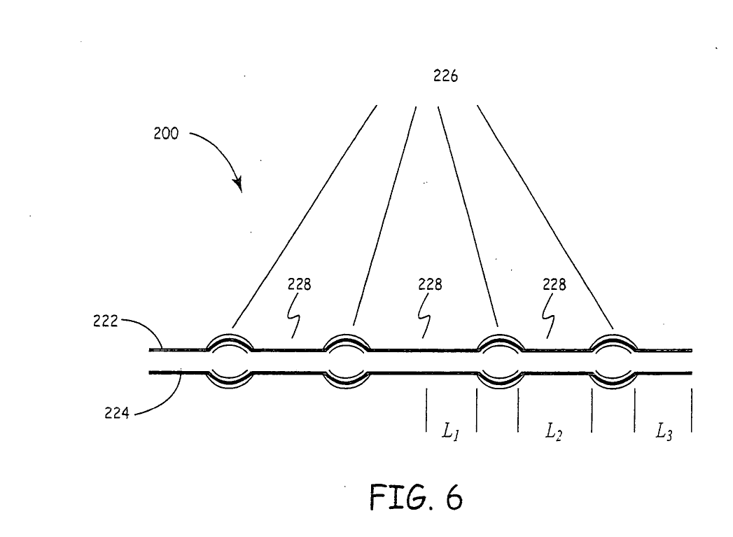

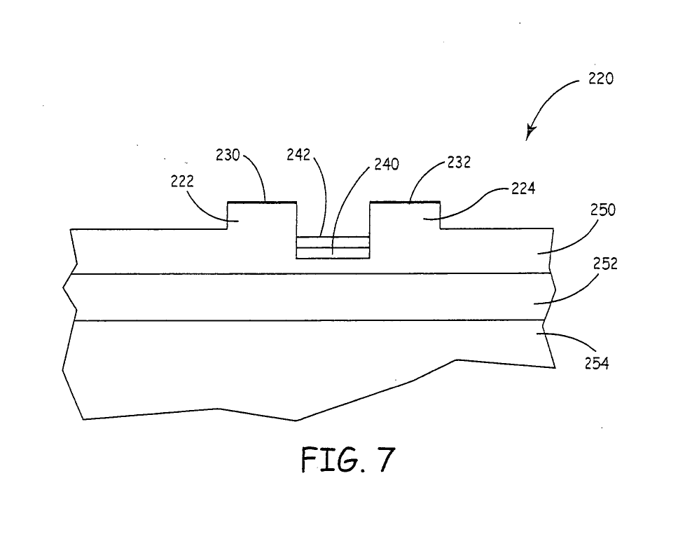

A coupler 220 illustrated in FIG. 6 in accordance with the present invention which uses straight parallel waveguides 222 and 224 partitioned to add curved sections 226 between the partitions 228. These curved sections 226 increase the gap between the waveguides to have almost zero coupling. A 180° phase shift length (on the order of 0.2 μm in semiconductors) is included in one of the sides of the curved sections. This extra length is too small to appear in the Figure. L₁, L₂, and L₃ are distances illustrated in FIG. 4A. Here coupling variations are obtained by means of etching steps between the guides in steps as shown in FIG. 7. The highest step can be at L₁, next at L₂ and lowest or deepest step at L₃.

FIG. 7 is a cross-sectional view of the coupler 220 shown in FIG. 6. Coupler 220 includes electrodes 230 and 232 which overly ridge waveguides 222 and 224, respectively. In the cross-sectional view, two steps, step 240 and 242, are visible in the upper cladding layer 250. The cladding layer 250 is deposited on guide layer 252 carried on substrate 254. The steps 240, 242 can be formed using any appropriate technique for the selected material. Referring back to FIG. 6, a step should be positioned at L₁, L₂ and L₃. Steps 242 and 240 provide a trench which extends between the two optical waveguides 222 and 224. The trench provides variable coupling between the two waveguides 222 and 224. The variations in the trench depth may be either stepped or continuous. The depth may be continuously variable across any desired length.

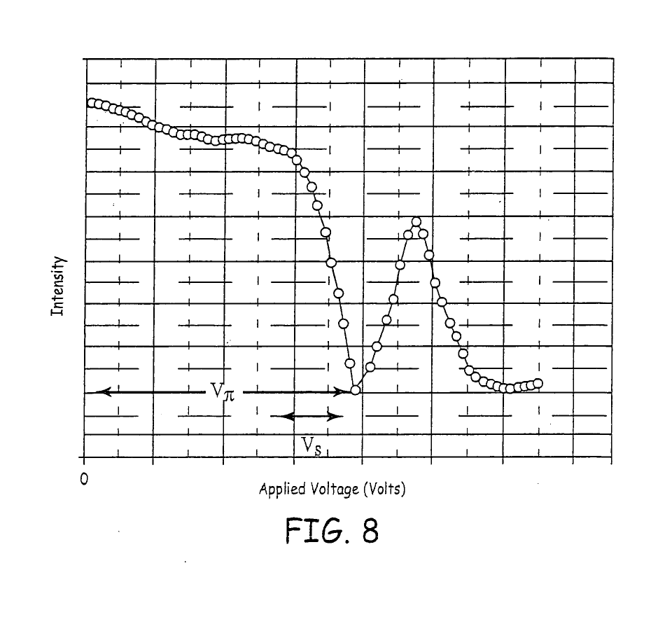

Using the embodiments of FIGS. 6 and 7, a resulting response is shown in FIG. 8 which is a graph of intensity of light through the device versus applied voltage. In this case, the response obtained is in the form of a half-trapezoid with additional side lobes. This response is fairly close to the predicted response. Thus, it is possible to realizes the designs, implement the required phase shift to obtain negative coupling, and build modulators which behave as predicted in semiconductor material.

Co-directional couples can be used as filters. Variable coupling optical couplers with no change in coupling sign, the so called weighted coupler discussed by Alferness (see Titanium-Diffused Lithium Niobate Waveguide Devices, in Guided Wave Optoelectronics, Editor: T. Tamir, Springer-Verlag, second edition, pp. 145-210, 1988), have shown reasonable filtering capabilities. These configurations have used exponential and other forms of coupling variation, typically with the one straight guide and a second guide with a decreasing spacing having a form of one of these functions to a minimum, and then symmetrically increasing the spacing. Although these filters also use the Fourier method. The filters are not narrow band.

A second type of filter uses vertical couplers. Vertical couplers are designed with guides stacked above each other with a spacer between them. The guides are of different widths, so as to have different mode velocities, and phased matched at a single wavelength (See for example, S.-K. Han, R. V. Ramaswamy, R. F. Tavlykaev, Narrow band vertically stacked filters in InGaAlAs/InP at 1.5 ¹m, Journal of lightwave Tech., vol. 14, no. 1, pp. 77-83, 1996). With the rapid fall of phase match at a particular wavelength, the transfer characteristics are frequency dependent and result in a filtering response. The filters are relatively narrow band, demonstrated to be of the order of 18° A, which are adequate for widely spaced WDM (wavelength division multiplexing) channels but inadequate for dense WDM, with 100 GHz spacing. The use of gratings in one of the guides or in the spacer between the guides have also been used to provide the narrow band phase match of the two guide velocities. (See for example, R. C. Alferness, L. L. Buhl, U. Koren, B. I. Miller, M. G. Young, t. L. Koch, C. A. Burrus, G. Raybon, Broadly tunable InGaAsP/InP buried rib waveguide vertical coupler filter, Appl. Phys. Lett., Vol. 60, no. 8, pp. 980-982, 992).

Synthesis of the grating function, periodicity and changes therein in the grating coupled contra-directional coupler can be used to obtain a specified filter response. These techniques may also be modified to obtain specific filter response with the variable coupling co-directional coupler (See T. Li, C. Laliew, A. Gopinath, An iterative transfer matrix inverse scattering technique for synthesis of co-directional couplers and filters, IEEEJ. Quantum Electronics, vol. 38, pp. 375-379, April 2002). When realized in electro-7.

Optic material and the filter can also be tuned. The tuning range depends on the material electro-optic coefficient. Since both the desired amplitude and phase response can be obtained with the variable coupling co-directional coupler, techniques can be used to synthesize the coupling function for a dispersion compensator such as those originally designed for a grating function in the contra-directional coupler (See Eva Peral, Jose Capmany and Javier Marti “Iterative Solution to the Gel'Fand-Levitan-Marchenko Coupled Equations and Application to Synthesis of Fiber Gratings”, IEEE J.Quantum Electronics, Vol. 32 pp 2078-2084, 1996).

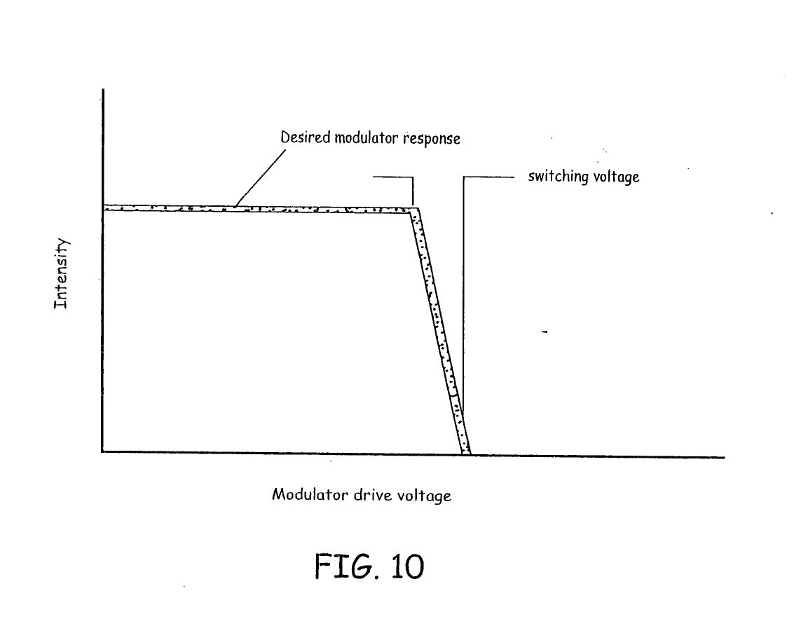

The present invention provides a co-directional coupler with variable coupling can be used as a modulator, filter, dispersion compensator, switch, with specified response functions, and similar devices. The techniques described above provide a design methodology for a co-directional coupler with variable coupling to used as an optical modulator, filter, dispersion compensator, switch with specified response, or other devices. In a specific implementation for a modulator which is designed to have a high linearity with a very low switching voltage, a trapezoidal type response may be implemented as shown in FIG. 10. While this is the ideal desired response for modulators, using the methodology discussed above, the associated coupling function is usually truncated to three or five lobes about the center. The truncated coupling function produces a response which has ripples both at the flat top region and also in the zero response region.

To obtain reasonable switching voltages for the modulator, the guides should be parallel to each other and partioned in the positive and negative coupling regions. Between these partitions, the spatially variable coupling function needs to change sign.

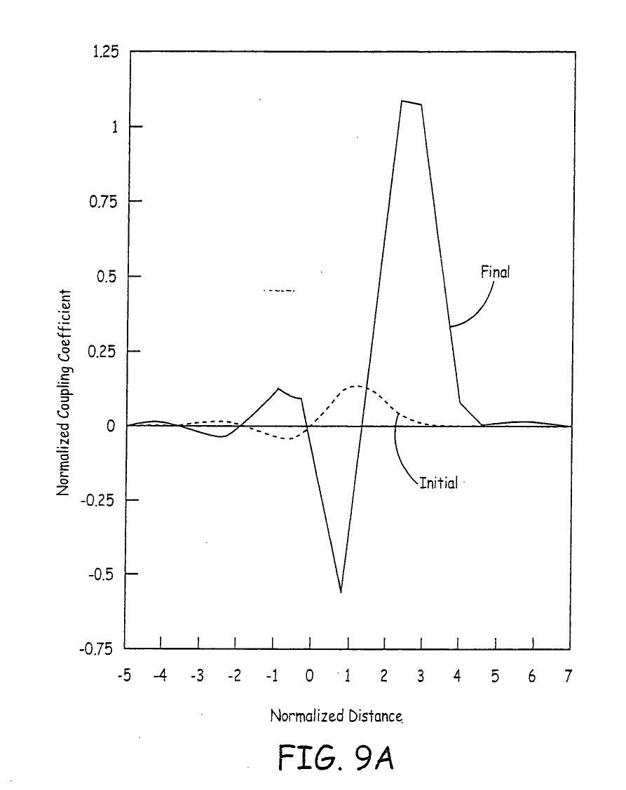

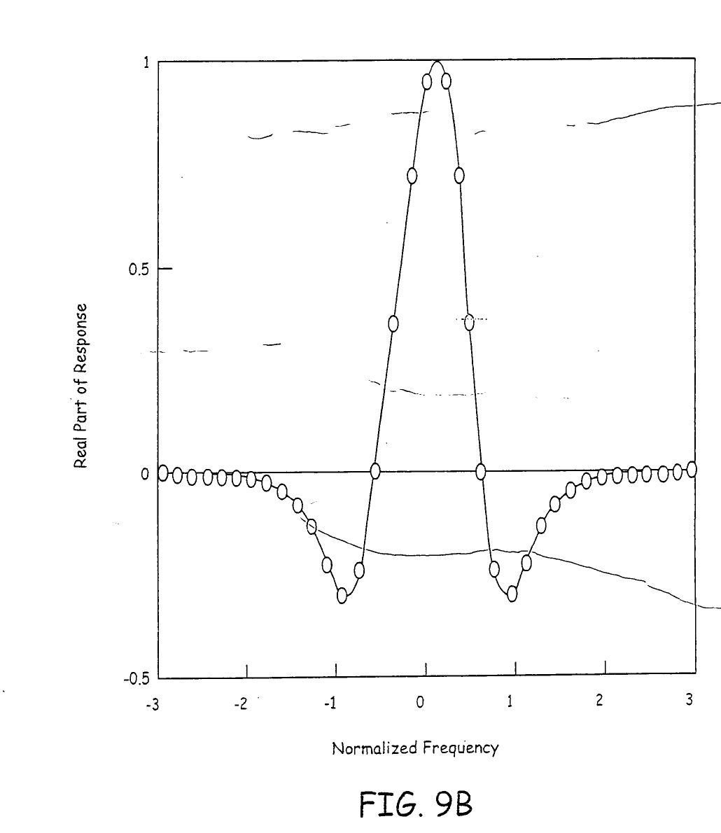

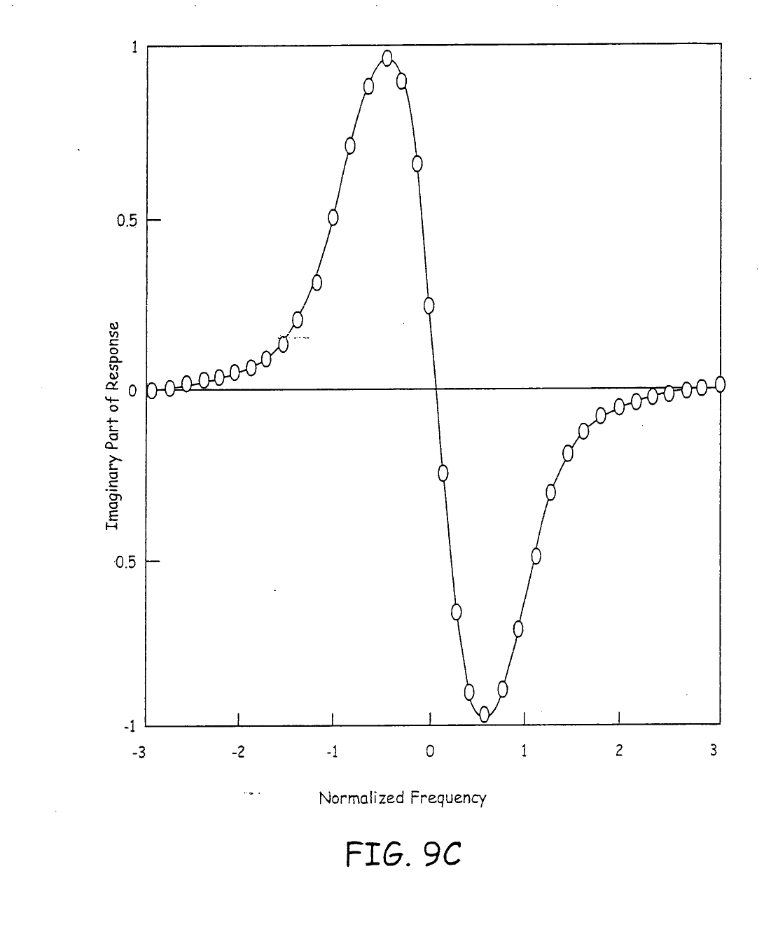

A coupling sign change can be implemented in optical waveguides by introducing curved sections between the partitions as discussed above. These curved sections increase the gap between the waveguides to provide negligible coupling. A 180° phase shift length can be included in one of the sides of this curved section which are shown in FIGS. 5 and 6. The variable coupling functions derived from these designs or other techniques, are real but have both positive and negative values and may be realized in any implementation by including an additional half wavelength in one arm of the appropriate section of the coupler to achieve the desired phase shift. The variation of coupling (either positive or negative) may be implemented by adding or re-moving the material between the guides, in a manner calibrated to obtain the designed coupling variation. In most material, this would take the form of smoothly varying the etch depth between the ridge guides shown in FIG. 7 to obtain the appropriate coupling variation. The above synthesis techniques may be used to build filters with specific response functions, both amplitude and phase, which in turn can provide in dispersion compensators, and other devices. FIG. 9A is a graph of the normalized coupling coefficient versus normalized distance for initial coupling function obtained using a Fourier transform method and a final coupling function obtained using an iterative Newton's method. FIG. 9B is a graph of a real part of a response versus normalized frequency. FIG. 9C is a graph of the imaginary part of the response versus normalized frequency for a dispersion compensator using the final coupling function. Further, the Newton's method can be modified to fit the linear region of the response preferentially, so that the linearity is improved as well as the fit of the rest of the response. This involves a simple modification to Newton's method which weights the error between calculated and desired response most heavily in the center of the sloped region, and less heavily in the center of the sloped region, and less heavily farther from this point. Since the iterative Newton's method attempts to minimize the total error, weighting causes it to improve both the linear region and the rest of the response. This is a substantial improvement to the synthesis method because it allows variable coupling directional coupler modulators with greater response linearity.

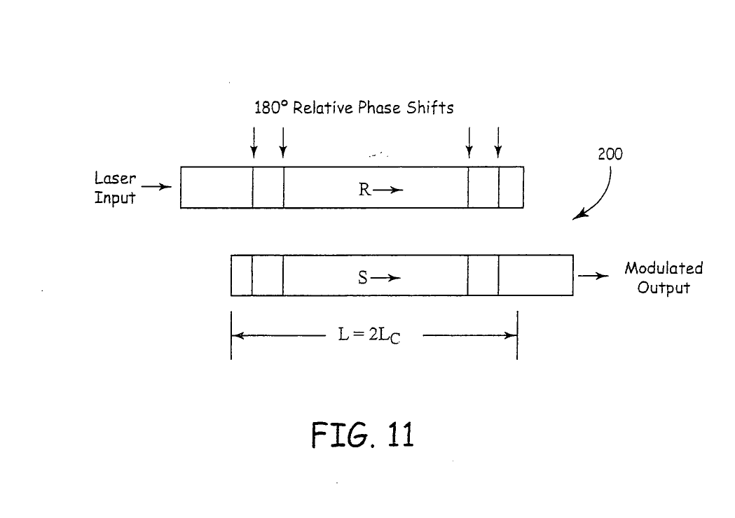

In one aspect, the present invention provides an electro-optic modulator design based on the optical directional coupler that offers relatively linear intensity response, in a fairly simple package. A schematic diagram of a modulator 200 is shown in FIG. 11. It is similar to the conventional directional coupler modulator, consisting of two identical, parallel optical waveguides with electrodes on them. The difference is that four phase shift sections have been added at specific points along its length. Each section delays the light in one waveguide with respect to the other by one-half period, producing a 180° relative phase shift. This is possible by making one waveguide optically longer than the other by λ/2, such as through waveguide bends. (See, C. Laliew et al, “A Linearized Optical Directional Coupler Modulator at 1.3 μm,” IEEE J. Lightwave Technology, vol. 18, pp. 1244-9, September 2000). It can be shown that phase shifts such as these can profoundly influence the behavior of the directional coupled modulator, in this case improving the linearity of the response.

The response of the modulator was determined using a transmission matrix approach. The optical fields at the beginning and end of a section of coupler of length L_{I} were related by (see, T. Li, C. Laliew and A. Gopinath, “An Iterative Transfer Matrix Inverse Scattering Technique for the Synthesis of Co-Directional Optical Couplers and Filters,” IEEE J. Quantum Electronics, vol. 38, pp. 375-9, April 2002):

$$\begin{matrix}[ \begin{matrix}{R}_{End} \\ {S}_{End}\end{matrix} ] = [ \begin{matrix}{t}_{11} & {t}_{12} \\ {t}_{21} & {t}_{22}\end{matrix} ] [ \begin{matrix}{R}_{Beginning} \\ {S}_{Beginning}\end{matrix} ] & EQ . 1 \\ {t}_{11} = {t}_{22} = cos ( {sL}_{i} ) + \frac{j δ sin ( {sL}_{i} )}{s} & EQ . 2 \\ {t}_{12} = {t}_{21} = - \frac{jk sin ( {sL}_{i} )}{s} & EQ . 3 \\ s ≡ \sqrt{{k}^{2}} + {δ}^{2} & EQ . 4\end{matrix}$$

where R and S are the normalized electric fields in the two waveguides, k is the coupling coefficient, and δ is the detuning parameter, which is linearly proportional to applied voltage (see, R. C. Alferness, “Waveguide Electrooptic Modulators,” IEEE Trans. Microwave Theory Tech., vol. TMM-30, pp. 1121-1137, August 1982). Under the assumption that each phase shift section could be made much shorter than the coupling length of the directional coupler, given by L_{C}≡π/2k, the transmission matrices for the phase shifts were approximated as:

$${T}_{PhaseShift} = [ \begin{matrix}1 & 0 \\ 0 & - 1\end{matrix} ] \qquad EQ . 5$$

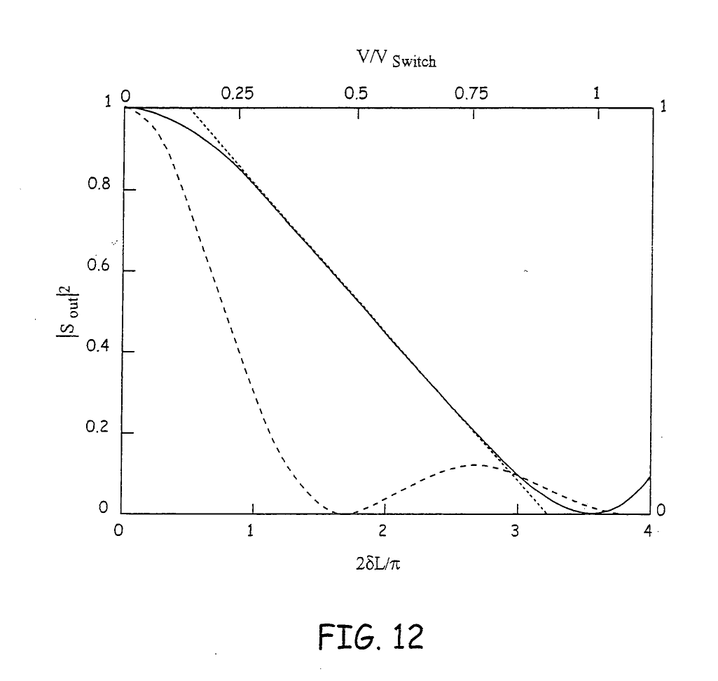

Matrix multiplication was then used to determine the power output, or intensity response, of the modulator, |Sₒᵤₜ(δ)|². This was done systematically for different device lengths and phase shift positions, with the initial condition |Rᵢₙ|²=1. In each case the phase shifts were placed symmetrically about the center of the coupler, which was found to keep the phase response constant and prevent signal chirp. Throughout the analysis there was one design that demonstrated superior intensity response linearity, as calculated over a region Δ|S|²=0.30. This had total length 2L_{C}, and phase shifts placed optimally at positions 5.98%, 18.69%, 81.31% and 94.02% along the length of the coupler. These percentages are given to two decimals places of accuracy, in accordance with the present invention the placement of the phase shifts need only be approximately at these locations, for example at about 6%, about 19%, about 81% and at about 94%, or can be positioned at other locations as desired. Further, in some applications the present invention can be used with more or less than the four phase shifts discussed herein. The response for this design is displayed in FIG. 12, plotted versus 2δL/π on the lower axis, and in normalized coordinates V/V_{switch} on the upper axis. The region 0.3≦|S|²≦0.6 was fit to a straight line as shown to illustrate that this region was essentially linear. For comparison, the response of the conventional directional coupler modulator (see, L. A. Coldren and S. W. Corzine, Diode Lasers and Photonic Integrated Circuits, New York: Wiley, 1995) was also included in FIG. 12. This shows that the phase-shifted modulator offers greater response linearity, but at some expense in switching efficiency.

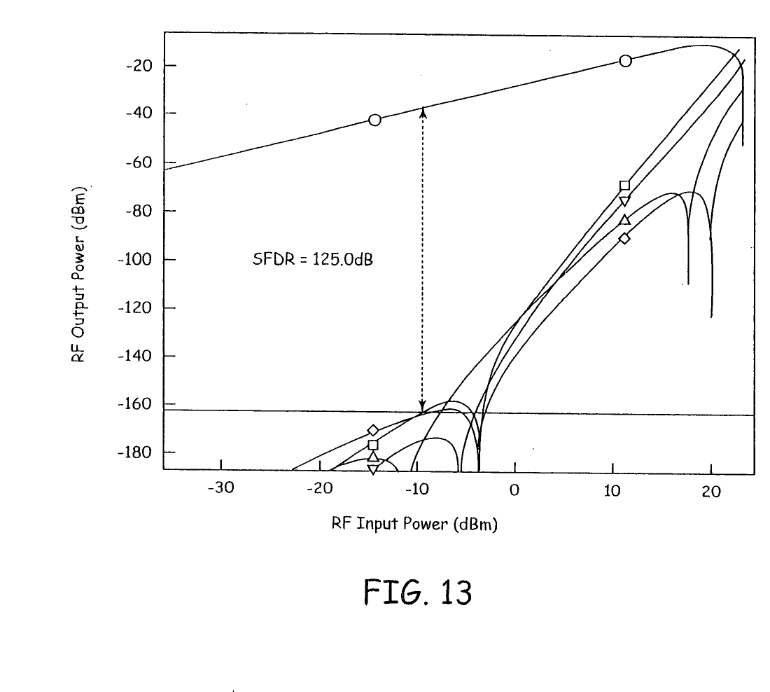

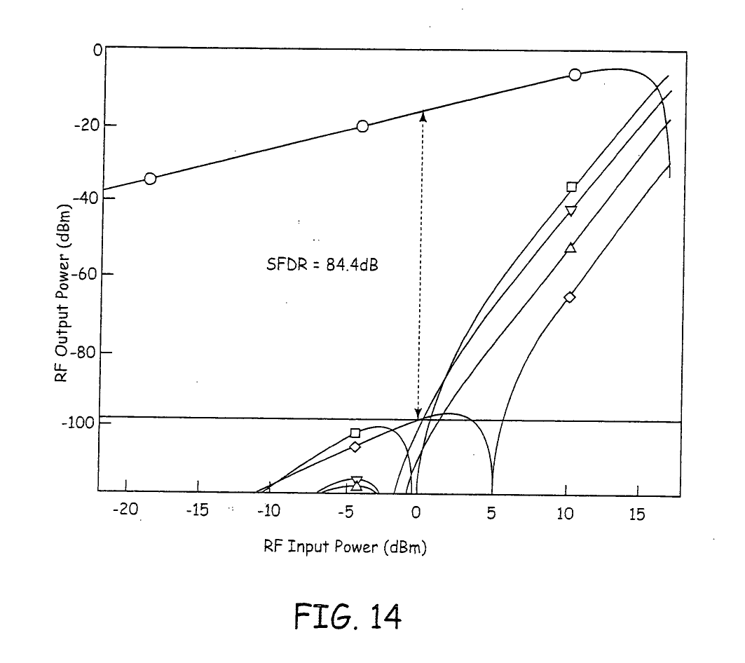

The linearity of the response was gauged by calculating the distortions produced in converting a two-tone input voltage of the form:
V(t)=V_{Bias}+V_{M}[sin(ωₐt)+sin(ω_{b}t)] EQ. 6
to an optical carrier. Nonlinearities in the response cause the output optical signal to include not only DC and fundamental signal components (at frequencies ωa and ωb), but also distortion products including second harmonics (2ωₐ, 2ω_{b}), third harmonics (3ωₐ, 3ω_{b}), second-order intermodulation distortions (IMD2) (|(wₐ±ω_{b}|), and third order intermodulation distortions (IMD3) (|2ωₐ±ω_{b}|, |(2ω_{b}±ωₐ) (see, G. M. Kizer, Microwave Communication, Ames, Iowa: Iowa State University Press, 1990). The optical power in each component was determined using a power series expansion technique (see, R. C. Alferness, “Waveguide Electrooptic Modulators,” IEEE Trans. Microwave Theory Tech., vol. TMM-30, pp. 1121-1137, August 1982), which fit the region of the response from V_{Bias}−V_{M} to V_{Bias}+V_{M} as a fifth-order power series about V_{Bias}. This was done for a wide range of voltages V_{Bias} and V_{M}, using the link parameters in Table I (a complete description of the link model is given in (see, S. A. Hamilton et al, “Comparison of an In-Line Asymmetric Directional Coupler Modulator with Distributed Optical Loss to Other Linearized Electrooptic Modulators,” IEEE Trans. Microwave Theory Tech., vol. 47, pp. 1184-1193, July 1999). For each bias voltage, it was then possible to plot the electrical power detected in each component at the end of the link versus RF input power, as shown in FIGS. 13 and 14. The noise powers in FIGS. 13 and 14 were calculated as the sum of the thermal, shot and relative intensity noise of the link, given by (see, W. B. Bridges and J. H. Schaffner, “Distortion in Linearized Electrooptic Modulators,” IEEE Trans. Microwave Theory Tech., vol. 43, pp. 2184-2197, September 1995 and S. A. Hamilton et al, “Comparison of an In-Line Asymmetric Directional Coupler Modulator with Distributed Optical Loss to Other Linearized Electrooptic Modulators,” IEEE Trans. Microwave Theory Tech., vol. 47, pp. 1184-1193, July 1999):
P_{Noise}=└(G+1)kT+f²(2qI_{DC}R_{L}+I_{DC}²R_{L}RIN)┘ EQ. 7
where G is the link gain, k is the Boltzman's constant, T is the absolute temperature, q is the electron charge, I_{DC} is the DC photocurrent in the photodiode, and f is the fraction of the photocurrent directed to the load,

$$f = \frac{{R}_{T}}{{R}_{T} + {R}_{L}} \qquad EQ . 8$$

These were used to determine the spurious free dynamic range (SFDR) of the link, calculated using

$$SFDR = \frac{{P}_{FundamentalSignal}}{{P}_{Noise}} {\vert}_{{P}_{Max Distortion} = {P}_{Noise}} \qquad EQ . 9$$

as illustrated graphically in FIGS. 13 and 14. The bias voltage was then chosen to maximize the SFDR, for each of the two sets of parameters in Table I. For set A, the optimal bias was V/V_{Switch}=0.5583 and the SFDR was 84.4 dB in 1 MHz, as shown in FIG. 13. For set B the optimal bias was V/V_{Switch}=0.545 and the SFDR was 125.0 dB in 1 Hz, illustrated in FIG. 14. Note that for set B the phase shifts were moved slightly to optimize the SFDR, to positions 5.933%, 18.617%, 81.383% and 94.067% along the total length of the device.

The link parameters in Table I match those used previously to compare distortion in different modulator designs (see, W. B. Bridges and J. H. Schaffner, “Distortion in Linearized Electrooptic Modulators,” IEEE Trans. Microwave Theory Tech., vol. 43, pp. 2184-2197, Sept. 1995 and S. A. Hamilton et al, “Comparison of an In-Line Asymmetric Directional Coupler Modulator with Distributed Optical Loss to Other Linearized Electrooptic Modulators,” IEEE Trans. Microwave Theory Tech., vol. 47, pp. 1184-1193, July 1999), and therefore allow the phase-shifted directional coupler to be included in the comparison. This has been done in Table II, which lists link properties for various modulator designs. In each case the SFDR quoted includes suppression of the IMD3 and either the second harmonic (see, S. A. Hamilton et al, “Comparison of an In-Line Asymmetric Directional Coupler Modulator with Distributed Optical Loss to Other Linearized Electrooptic Modulators,” IEEE Trans. Microwave Theory Tech., vol. 47, pp. 1184-1193, July 1999) or IMD2 (see, W. B. Bridges and J. H. Schaffner, “Distortion in Linearized Electrooptic Modulators,” IEEE Trans. Microwave Theory Tech., vol. 43, pp. 2184-2197, September 1995). It can be seen that the phase-shifted directional coupler offers a significant improvement in SFDR compared to the Mach-Zehnder and conventional directional coupler modulators. 12-15 dB, which is comparable to the best linearized modulator designs.

TABLE I
FIBER-OPTIC LINK PARAMETERS

| Parameter | Symbol | Set A | | Set B | |
|---|---|---|---|---|---|
| Laser Power | P_{L} | 0.1 | W | 0.1 | W |
| Laser Noise | RIN | −165 | dB/HZ | −165 | dB/HZ |
| Total Optical Loss | L₀ | 0.6 | | 0.9 | |
| Modulator Sensitivity | V_{Swtich} | 5 | V | 10 | V |
| Modulator Impedance | R_{M} | 50 | Ω | 50 | Ω |
| Detector Responsivity | η_{D} | 0.7 | A/W | 0.7 | A/W |
| Detector Termination | Rᵣ | 50 | Ω | ∞ | |
| Load Impedance | R_{L} | 50 | Ω | 50 | Ω |
| Noise Bandwidth | B | 1 | MHz | 1 | Hz |

The gain and noise figure of each link are also listed in Table II, calculated using parameter set A and the equations:

$$\begin{matrix}G = {R}_{L} {{R}_{M} [ ( \frac{{P}_{L} {η}_{D} f ( 1 - {L}_{0} )}{{V}_{Switch}} ) ( \frac{\partial {\vert S \vert}^{2}}{\partial ( V \vert {V}_{Switch} )} {\vert}_{Vbias} ) ]}^{2} & EQ . 10 \\ NF = \frac{{P}_{Noise}}{GkTB} & EQ . 11\end{matrix}$$

for link gain and noise figure, respectively. Comparing the results in Table II shows that the phase-shifted directional coupler offers and improvement in SFDR without a great sacrifice in link gain or noise figure, in contrast to many linearized designs.

TABLE II
PERFORMANCE OF FIBER-OPTIC LINKS
WITH PARAMETERS OF TABLE I

| | SFDR^{A} | SFDR^{B} | Link | Noise |
|---|---|---|---|---|
| | (dB in | (dB in | Gain^{A} | Figure^{A} |
| Modulator Type | 1 MHz) | 1 Hz) | (dB) | (dB) |
| Phase-Shifted | 84.4 | 125.0 | −14.8 | 29.3 |
| Directional Coupler | | | | |
| Conventional | 71.8 | 109.4 | −12.7 | 28.6 |
| Directional Coupler | | | | |
| Single Mach-Zehnder | 72.4 | 109.9 | −13.2 | 28.5 |
| (MZ) | | | | |
| Dual MZ (“Cubic”) | 81.8 | 126.2 | −26.2 | 41.6 |
| Series Directional | 81.1 | 127.1 | −18.5 | 33.8 |
| Coupler (2 Bias Sections, | | | | |
| “Cross”) | | | | |
| Asymmetric Directional | 81.4 | NA | −10 | 26.2 |
| Coupler^{C} | | | | |
| Series MZ/Directional | 85.1 | NA | −27.1 | 42.5 |
| Coupler | | | | |
| Triple MZ/(“Cubic- | 86.2 | 133.0 | 29.7 | 45.1 |
| Quintic”) | | | | |

This modulator design offers a simple method of obtaining linearized intensity response for analog links. The distortion suppression was shown to be comparable to other linearization schemes, offering a significant improvement in SFDR compared to simple modulators such as the Mach-Zehnder or conventional directional coupler, This is accomplished without chirping the optical signal.

The desired modulator response of the variable coupling directional coupler may also be obtained with a single coupling value, with only sign changes along the length of the modulator. In designing this structure, the coupling value and the various lengths between the sign changes may be obtained using the Fourier transform method followed by iterations in order to obtain the desired response. However, other techniques may also be used. The required coupling may be obtained by etching between the guides in semiconductor and polymer structures, by controlling the distance between the guides and semiconductors, polymer, lithium niobate structures, and other electro-optic materials. A sign change between sections can be obtained, for example, by introducing a section having an additional half wavelength in one of the arms of the coupler at the required point.

The required filter amplitude and phase response of the variable coupling directional coupler may also be obtained with a single coupling value and with only sign changes along the length of the filter. In the design of this structure, the coupling value and the various lengths between the sign changes can be obtained using the Fourier transform method followed by iterations to obtain the required response, or by other appropriate techniques. The sign change between sections can be obtained by introducing an additional half wavelength section in one of the arms of the coupler at the required point.

Although the present invention has been described with reference to preferred embodiments, workers skilled in the art will recognize that changes may be made in form and detail without departing from the spirit and scope of the invention. The devices can be fabricated in any appropriate material which shows electro-optic effects including semiconductors.

1. An optical modulator comprising:
a substrate;
a first elongate optical waveguide on the substrate;
a second elongate optical waveguide on the substrate which extends adjacent to and parallel with the first elongate optical waveguide;
a plurality of phase shifts along a length of the first and second waveguides, the plurality of phase shifts configured to provide a linear response in the modulator; and wherein the plurality of phase shifts are provided by changing a length of one waveguide relative to the other waveguide and the first and second elongate optical waveguides have constant coupling.

2. The apparatus of claim 1 wherein there are four phase shifts.

3. The apparatus of claim 2 wherein the phase shifts are positioned about 6%, 19%, 81% and 94% along the length of the first and second waveguides.

4. The apparatus of claim 1 wherein a difference in length is about λ/2.

5. The apparatus of claim 1 including a trench extending between the first elongate optical waveguide and the second elongate optical waveguide.
